(19) United States
(12) Patent Application Publication
(10) Pub. No.: US 2007/0076098 A1
(43) Pub. Date: Apr. 5, 2007

(54) Anti-vibration device and camera apparatus using the same

(75) Inventor: Yuichi Yasuda, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/528,008

(22) Filed: Sep. 27, 2006

(30) Foreign Application Priority Data
Sep. 30, 2005 (JP) 2005-287234

(51) Int. Cl. H04N 5/228

(52) U.S. Cl. 348/208.99

(57) ABSTRACT

An anti-vibration device and a camera apparatus using the same are provided. The anti-vibration device includes an actuator that supports one end portion of a cantilever support arm. A camera module, which is a support member, is suspended and supported by the other end portion of the support arm. The support arm is provided with a vibration detecting element capable of detecting vibration of the support arm, which vibrates in conjunction with vibration of a chassis. The vibration detecting element can output a predetermined electrical signal upon detection of the vibration of the support arm. The actuator can perform control to reduce the electrical signal output by the vibration detecting element, in response to the vibration of the support arm caused by the vibration of the chassis.

This application claims the benefit of Japanese Patent Application No. 2005-287234 filed Sep. 30, 2005, which is hereby incorporated by reference.

### BACKGROUND

1. Field

The present embodiments relate to an anti-vibration device and a camera apparatus using the same, and more particularly to an anti-vibration device and a camera apparatus using the same capable of appropriately preventing vibration from being transmitted to a camera module.

2. Related Art

A conventional anti-vibration device and a camera apparatus using the same will be described in accordance with Japanese Unexamined Patent Application Publication No. 07-043769 with reference to FIG. 5. In the conventional anti-vibration device and the camera apparatus using the same, a lens barrel unit 52, which is a support member, is supportedly built in a hollow interior of a chassis 51.

The lens barrel unit 52 includes a lens barrel body 54 for holding a photographing lens 53, an independent rotation member 55 rotatably supported by the lens barrel unit 52, and two driving sections, for example, an X-axis drive section and a Y-axis drive section which are anti-vibration devices for driving to rotate the lens barrel unit 52 with respect to mutually perpendicular X and Y axes.

The X-axis drive section includes a first drive motor 56 fixed to the chassis 51, a gear array 56b driven by an output pinion 56a of the first drive motor 56, a drive shaft 56c driven by the gear array 56b and rotatably provided around an Xo axis, and a drive gear 56d fixed to the drive shaft 56c.

The Y-axis drive section includes a second drive motor 57 fixed to the chassis 51, a gear array 57b driven by an output pinion 57a of the second drive motor 57, a drive shaft 57c driven by the gear array 57b and rotatably provided around a Yo axis, and a drive gear 57d fixed to the drive shaft 57c.

The independent rotation member 55 is rotatably supported on the X axis of the lens barrel body 54. The independent rotation member 55 is formed with a first V-groove 58 along a circular arc passing through the X axis. The first V-groove 58 is supported in contact with a spherical surface end portion (not illustrated) of the drive shaft 56c.

The independent rotation member 55 is formed with a face gear 59, along the first V-groove 58, which rotates around an axis passing through a rotation center point G of the lens barrel body 54.

The face gear 59 is meshed with the drive gear 56d. When the drive gear 56d rotates, the lens barrel body 54 is rotated via the independent rotation member 55 around the Y axis perpendicular to the X axis.

The lens barrel body 54 is formed, at an upper part thereof and around the rotation center point G, with a second V-groove 60 along a circular arc passing through the Y axis and an optical axis O. The second V-groove 60 is supported in contact with a spherical surface end portion (not illustrated) of the drive shaft 57c.

The lens barrel body 54 is formed with a face gear 61, along the second V-groove 60, which rotates around the X axis. The face gear 61 is meshed with the drive gear 57d. Thus, when the drive gear 57d rotates, the lens barrel body 54 is rotated around the X axis perpendicular to the Y axis.

According to the thus configured conventional anti-vibration device, the hand shake caused by an operator who holds the chassis 51 can be corrected by driving to rotate the lens barrel body 54 in horizontal or vertical directions in response to the vibration of the chassis 51.

Another conventional anti-vibration device is described in Japanese Unexamined Patent Application Publication No. 61-150580.

In the conventional anti-vibration device and the camera apparatus using the same, however, the drive force of the first and second drive motors 56 and 57 is transmitted to the lens barrel body 54 via the gear arrays 56b and 57b, each of which includes a plurality of gears. Therefore, when a backlash is generated among the plurality of gears in the respective gear arrays 56b and 57b, even if the first and second drive motors 56 and 57 are driven to rotate in response to the vibration of the chassis 51 caused by the hand shake or the like, the rotation drive cannot be promptly transmitted to the lens barrel body 54. Thus, there is a possibility that appropriate hand shake correction may not be performed.

The conventional anti-vibration device is provided with and surrounded by the first and second drive motors 56 and 57 and the gear arrays 56b and 57b each including the plurality of gears. Therefore, when the lens barrel unit 52 is reduced in size to be used in a mobile phone or the like, an obtained camera apparatus is increased in size. Thus, the conventional anti-vibration device is difficult to be used in a small-size apparatus, such as the mobile phone.

The present embodiments have been made in view of the above-described circumstances, and it is therefore one exemplary object of the present embodiments to provide an anti-vibration device and a camera apparatus using the same capable of appropriately absorbing vibration of a chassis and preventing vibration of a support member held in the chassis.

### SUMMARY

According to a first embodiment, an anti-vibration includes a support member supported by a chassis, and actuators fixed to the chassis and supporting the support member such that the support member can be driven to vibrate. Each of the actuators support one end portion of a cantilever support arm, and the support member is suspended and supported by the other end portion of the support arm. The support arm is provided with a vibration detecting element that can detect vibration of the support arm, which vibrates in conjunction with vibration of the chassis, and which can output a predetermined electrical signal upon detection of the vibration of the support arm. The actuator can perform control to reduce the electrical signal output by the vibration detecting element, in response to the vibration of the support arm caused by the vibration of the chassis.

According to a second embodiment, the actuator may be provided with a magnet, and a coil facing the magnet and cantilever-supporting the one end portion of the support arm. The vibration detecting element may output the electrical signal in response to the vibration of the chassis, and a control unit may detect the electrical signal and apply predetermined electric power to the coil in response to the electrical signal to cause the coil to vibrate in directions offsetting the vibration of the chassis.

According to a third embodiment, the actuator may include a frame that has a hollow interior and which is formed with mutually countervailing back and front yokes each formed of a magnetic material. The magnet may be fixed to the inner surface of the back yoke of the frame, and the coil may be provided to face the magnet with a gap of a predetermined side interposed between the coil and the magnet. At least a lower end surface of the coil may be supported by a resilient member attached to a lower side plate of the frame such that the coil can vibrate in directions parallel to the magnet.

According to a fourth embodiment, the support member may include one side surface and the other side surface, which face each other. The actuators may be fixed at least to one position on the chassis facing the one side surface and to two positions on the chassis facing the other side surface. The vibration of the chassis in X-axis directions and Y-axis directions may be detected by the vibration detecting element provided to each of the actuators.

According to a fifth embodiment, the resilient member may be formed by a blade spring, at least one end portion of which is fixed to the lower side plate of the frame, and the other end portion of which is attached to the lower end surface of the coil.

According to a sixth embodiment, the support arm may be formed into a plate shape having resiliency, and at least one surface of the plate shape may be provided with the vibration detecting element.

According to a seventh embodiment, the vibration detecting element may be formed by a resistor formed at least on the one surface of the support arm. When the coil vibrates and bending occurs in the support arm, a resistance value of the resistor may change in response to the bending of the support arm, and the electrical signal may be output.

According to an eighth embodiment, a film of the resistor may be formed by printing.

According to a ninth embodiment, the resistor may be carbon ink.

According to a tenth embodiment, the support member may include support portions each of which can be supported by the other end portion of the corresponding support arm. Each of the support portions may be formed with spherical surface portions or circular arc portions facing each other across a gap of a size equal to or larger than the thickness size of the corresponding plate-shaped support arm. The support member may be supported by the support arm, with the other end portion of the support arm nipped between the mutually facing spherical surface portions or circular arc portions.

According to an eleventh embodiment, a camera apparatus includes a camera module including an optical device and an image pickup device, a chassis for supporting the camera module, and actuators fixed to the chassis and supporting the camera module such that the camera module can be driven to vibrate. Each of the actuators includes a support arm having one end portion which is cantilever-supported, and the other end portion which suspends the camera module. The support arm is provided with a vibration detecting element which can detect vibration of the support arm occurring in response to vibration of the chassis. The actuator can perform control to reduce an electrical signal output by the vibration detecting element, in response to the vibration of the support arm, and the vibration of the chassis can be prevented from being transmitted to the camera module through the control of the actuator.

According to a twelfth embodiment, the camera module and the actuators may be built in a case of an electronic device, and the actuators may be directly installed in the case.

The support arm in the anti-vibration device according to the present invention is provided with the vibration detecting element capable of detecting the vibration of the support arm which vibrates in conjunction with the vibration of the chassis. The vibration detecting element can output the predetermined electrical signal upon detection of the vibration of the support arm. Each of the actuators can perform control to reduce the electrical signal output by the vibration detecting element, in response to the vibration of the support arm caused by the vibration of the chassis. With the electrical signal output by the vibration detecting element thus reduced, the vibration of the chassis can be prevented from being transmitted to the support member. Therefore, in a case in which the support member is the camera module, the camera module does not vibrate even if the chassis vibrates.

In one preferred embodiment, the actuator is provided with the magnet and the coil facing the magnet, and the one end portion of the support arm is cantilever-supported by the coil. In response to the vibration of the chassis, the electrical signal is output by the vibration detecting element. Upon detection of the electrical signal, the control unit applies the predetermined electric power to the coil in response to the electrical signal. The coil vibrates in the directions offsetting the vibration of the chassis, and the vibration of the chassis can be securely prevented from being transmitted to the support member.

In another preferred embodiment, the actuator includes the frame which has the hollow interior and which is formed with the mutually countervailing back and front yokes each formed of the magnetic material. The magnet is fixed to the inner surface of the back yoke of the frame, and the coil is provided to face the magnet with the interval of the predetermined size kept between the coil and the magnet. At least the lower end surface of the coil is supported by the resilient member attached to the lower side wall of the frame such that the coil can vibrate in the directions parallel to the magnet. Therefore, it is possible to effectually extract the energy of the magnet and to cause the coil to effectively and securely vibrate. Accordingly, the coil vibrates in the directions offsetting the vibration of the chassis, and the vibration of the chassis can be securely prevented from being transmitted to the support member.

In another preferred embodiment, the support member includes the one side surface and the other side surface, which face each other. The actuators are fixed at least to the one position on the chassis facing the one side surface, and to the two positions on the chassis facing the other side surface. The vibration of the chassis both in the X-axis directions and the Y-axis directions can be detected by the vibration detecting element provided to each of the actuators. Therefore, it is possible to definitely detect the vibration of the chassis in the directions of the two axes and to securely prevent the vibration of the support member.

In another preferred embodiment, the resilient member is formed by the blade spring, at least one end portion of which is fixed to the lower side plate of the frame, and the other end portion of which is attached to the lower end surface of the coil. Thus, the coil can be securely supported to vibrate. With the resilient member thus formed by the spring, it is possible to prevent the coil from vibrating in the through-thickness directions thereof and to cause the coil to effectively vibrate in one direction.

In another preferred embodiment, the support arm is formed into the plate shape having resiliency, and at least the one surface of the plate shape is provided with the vibration detecting element. Therefore, the vibration detecting element can definitely detect the vibration of the support arm.

In another preferred embodiment, the vibration detecting element is formed by the resistor formed on at least the one surface of the support arm. When the coil vibrates to cause bending in the support arm, the resistance value of the resistor changes in response to the bending of the support arm, and the electrical signal is output. Therefore, it is possible to highly accurately detect the vibration with a low-cost vibration detecting element.

In another preferred embodiment, the support member includes the support portions, each of which can be supported by the other end portion of the corresponding support arm, and each of the support portions is formed with the mutually facing spherical portions or circular arc portions having therebetween the gap of the size equal to or larger than the thickness size of the plate-shaped support arm. The support member is supported by the support arm, with the other end portion of the support arm nipped between the mutually facing spherical portions or circular arc portions. Therefore, the support arm is smoothly bent without difficulty in conjunction with the vibration of the chassis, and the bending can be definitely detected by the vibration detecting element.

The camera apparatus using the anti-vibration device according to the present invention includes the camera module including the optical device and the image pickup device, the chassis supporting the camera module, and the actuators fixed to the chassis and supporting the camera module such that the camera module can be driven to vibrate. Each of the actuators includes the support arm having the one end portion which is cantilever-supported, and the other end portion which suspends the camera module. The support arm is provided with the vibration detecting element capable of detecting the vibration of the support arm caused in response to the vibration of the chassis. The actuator can perform control to reduce the electrical signal output by the vibration detecting element, in response to the vibration of the support arm. The vibration of the chassis can be prevented from being transmitted to the camera module through the control of the actuator. Therefore, when an operator holding the camera apparatus causes a hand shake or the like, the hand shake is absorbed by the actuator, and the vibration of the camera module can be prevented. Accordingly, a high-resolution image unaffected by the vibration or the like can be obtained.

In another preferred embodiment, the camera module and the actuators are built in the case of the electronic device, and the actuators are directly installed in the case. Thus, the chassis can be used also as the case. Accordingly, the number of component parts can be reduced, and the camera apparatus can be reduced in thickness.

### BRIEF DESCRIPTION OF THE DRAWINGS

FIG. 1 is a perspective view illustrating a first embodiment;

FIG. 2 is a cross-sectional view of relevant part of the embodiment illustrated in FIG. 1;

FIG. 3 is a perspective view illustrating the actuator of the anti-vibration device according to an exemplary embodiment;

FIG. 4 is a schematic view illustrating a second embodiment; and

FIG. 5 is a perspective view of a conventional anti-vibration device and a camera apparatus using the same.

### DESCRIPTION OF THE PREFERRED EMBODIMENTS

An anti-vibration device according to the present embodiments and a camera apparatus using the same will now be described with reference to the drawings.

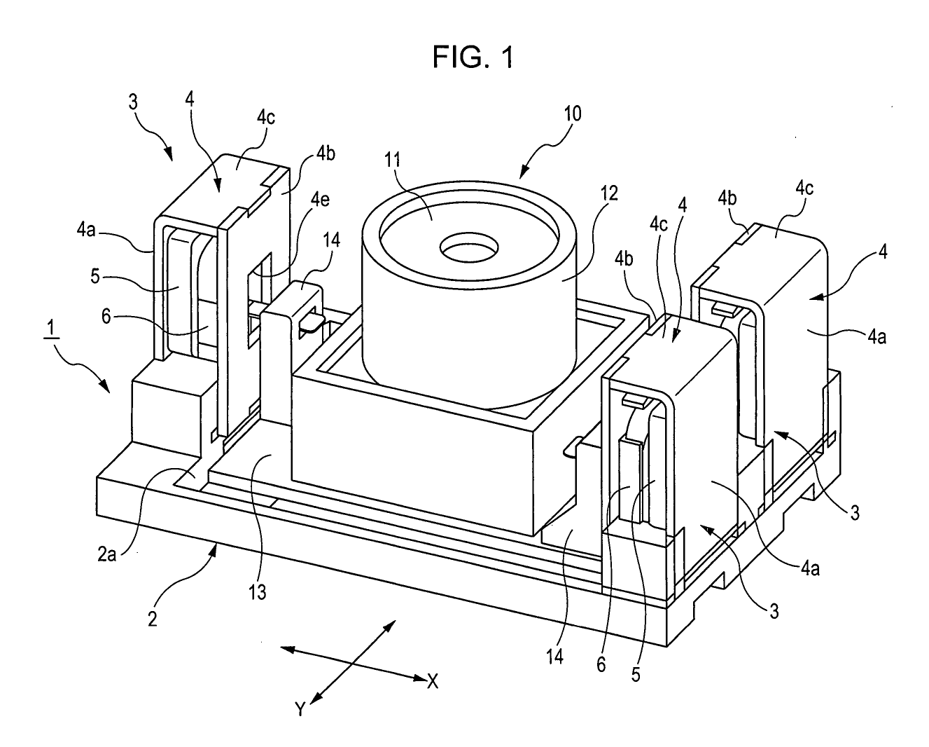

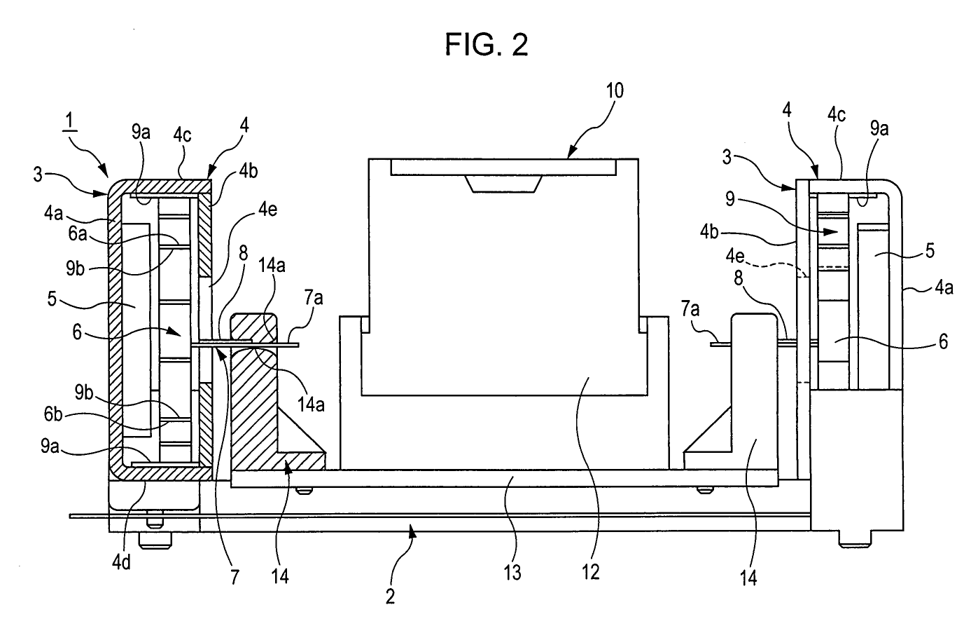

As illustrated in FIGS. 1 and 2, an anti-vibration device 1 according to a first embodiment includes, at the lowermost part thereof, a chassis 2, which is formed of a resin material or the like, and which has an approximately rectangular-shaped exterior. The chassis 2 is pierced with an opening 2a which is larger than a base plate 13 of a later-described camera module 10.

Actuators 3 are fixed to the right and left end portions of the chassis 2 illustrated in FIG. 1. The actuators 3 are fixed to one position on the chassis 2 facing one side surface of the later-described camera module 10, which is a support member, at the left side in FIG. 1, and to two positions on the chassis 2 facing the other side surface of the camera module 10 at the right side in FIG. 1.

The respective actuators 3 are the same in configuration. Thus, the configuration of the actuator 3 fixed to the left side of the chassis 2 illustrated in FIG. 2 will be described. In the actuator 3, a frame 4 having a hollow interior is fixed to the chassis 2. The frame 4 is formed by a back yoke 4a, a front yoke 4b, an upper side plate 4c, and a lower side plate 4d. The back yoke 4a and the front yoke 4b are each formed by a magnetic material, such as an iron plate, and countervail each other, with a predetermined gap formed therebetween.

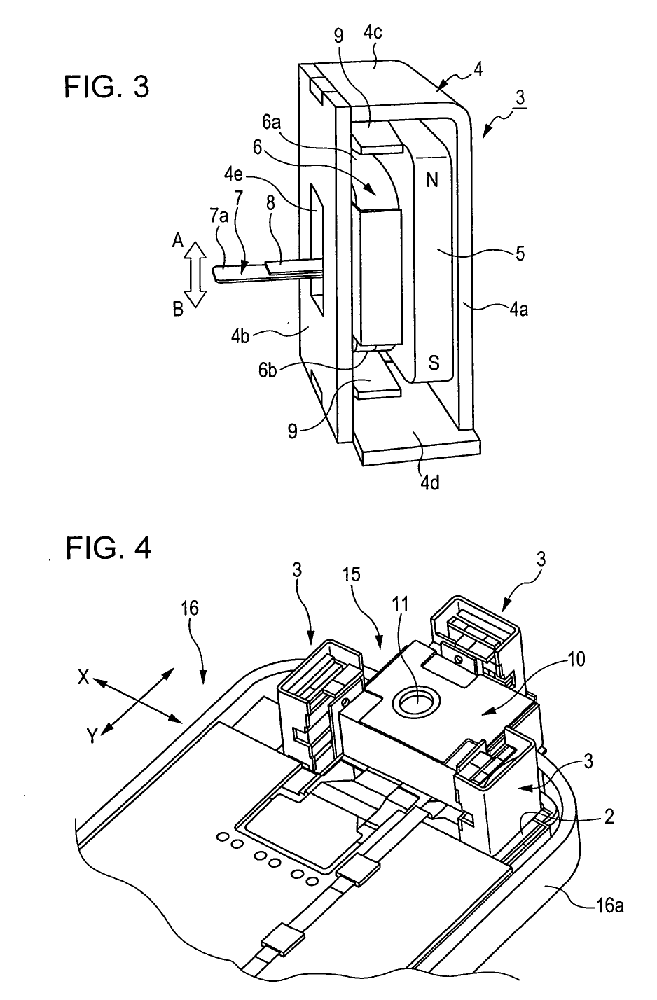

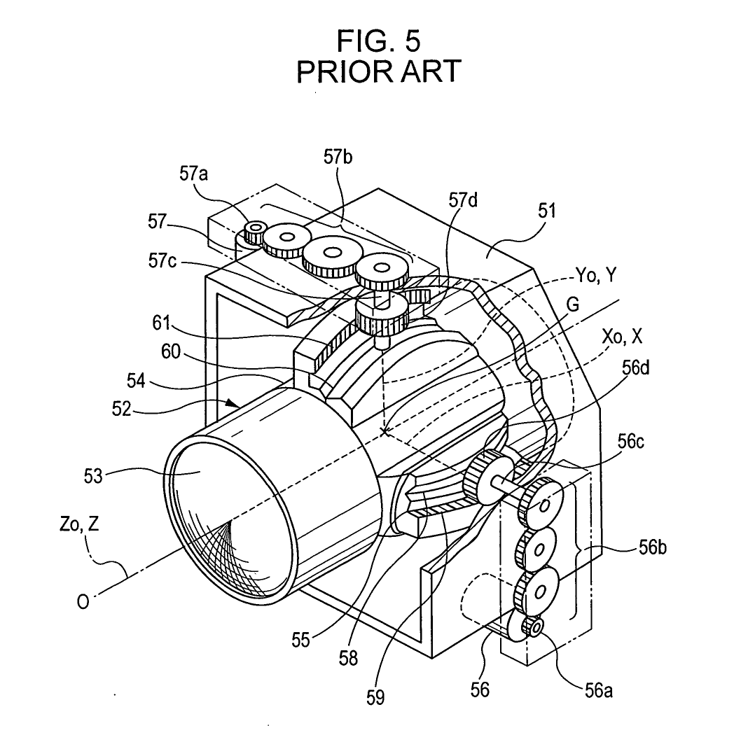

The inner surface of the back yoke 4a is fixed with an adhesive agent or the like to a magnet 5, which is a permanent magnet formed into an approximately rectangular shape having a predetermined thickness and a predetermined size. As illustrated in FIG. 3, magnetic fields are produced in the magnet 5 such that the upper side and the lower side of the magnet 5 serve as the north pole and the south pole, respectively, for example.

A coil 6 is provided to face the magnet 5 with a predetermined gap formed therebetween. At the center region of the coil 6, one end portion (the portion at the right side in FIG. 3) of a resilient, plate-shaped support arm 7 is cantilever-supported, and the other end portion 7a (the portion at the left side in FIG. 3) of the support arm 7 forms a free end.

In the support arm 7 cantilever-supported by the coil 6, the other end portion 7a, for example, the free end is inserted through an insertion hole 4e pierced through the front yoke 4b of the frame 4, to protrude outside the frame 4 by a predetermined length.

The support arm 7 is formed, on at least one surface (e.g., an upper surface) thereof, with a vibration detecting element 8 which is formed by a resistor printed with carbon ink. Alternatively, the vibration detecting element 8 may be formed on the other surface or both of the one surface and the other surface of the support arm 7.

As illustrated in FIG. 3, the coil 6 is wound into an approximately rectangular shape having a predetermined thickness, and both end surfaces of an upper end surface 6a and a lower end surface 6b are supported by respective resilient members 9 such that the coil 6 can vibrate. Each of the resilient members 9 is formed of a blade spring folded into an approximately V-shape. One end portion 9a of the resilient member 9 is fixed with an adhesive agent or the like to a corresponding one of the upper side plate 4c and the lower side plate 4d of the frame 4, and the other end portion 9b of the resilient member 9 is fixed with an adhesive agent or the like to a corresponding one of the upper end surface 6a and the lower end surface 6b of the coil 6.

Therefore, in the actuator 3, when the coil 6 is applied with predetermined electric power, a magnetic flux is generated and affects the magnetic flux of the magnet 5. Thereby, the coil 6 effectively vibrates in vertical directions indicated by arrows A and B in FIG. 3 against the biasing force of the resilient members 9.

For example, the coil 6 supported by the resilient members 9, which are formed by the blade springs, do not perform inefficient vibration, such as torsional vibration in horizontal directions in the drawing (i.e., the through-thickness directions of the coil 6) perpendicular to the directions indicated by the arrows A and B.

A total of the three actuators 3 thus configured are fixed to one position on the chassis 2 at the left side in FIG. 1, and to two positions on the chassis 2 at the right side in FIG. 1. Thus, the vibration of the chassis 2 in the X-axis directions and the Y-axis directions can be detected.

In a camera apparatus using the anti-vibration device 1, the camera module 10, which is the support member such as a digital camera, is suspended in midair and supported by the other end portions 7a of the respective support arms 7 of the three actuators 3.

The camera module 10 includes a lens 11 of a predetermined aperture, a lens barrel section 12 for supporting the lens 11, and the base plate 13 formed by a hard printed board having a predetermined thickness. The lens barrel section 12 is mounted on and fixed to the base plate 13. A part of the base plate 13 facing the lens 11 is provided with an image pickup device, such as a CCD (not illustrated).

Support portions 14 are fixed to positions on the right and left end portions of the base plate 13 illustrated in FIG. 1, which face the respective actuators 3.

As illustrated in FIG. 2, in each of the support portions 14, circular arc portions 14a are formed to face each other across a gap of a size equal to or larger than the thickness size of the corresponding plate-shaped support arm 7. Thus, the other end portion 7a of the support arm 7 is nipped between the mutually facing circular arc portions 14a.

According to this embodiment, the camera module 10, which is the support member, is suspended in midair and supported by the respective support arms 7.

The shape of the circular arc portion 14a of the support portion 14 is not limited to the circular arc shape. For example, the circular arc portion 14a may be a spherical surface portion (not illustrated), which is formed into a spherical surface shape.

The camera module 10, which is the support member, is suspended, with the other end portion 7a of each of the support arms 7 nipped between the circular arc portions 14a or the spherical surface portions of the corresponding support portion 14.

With the support arm 7 thus supported by the circular arc portions 14a or the spherical surface portions, even if the chassis 2 vibrates and internal stress is applied to the support arm 7, the support arm 7 can be smoothly bent with little resistance in response to the internal stress. Therefore, the vibration detecting element 8 can highly accurately detect even minute vibration of the chassis 2.

In the camera apparatus using the thus configured anti-vibration device 1, if the chassis 2 vibrates due to the hand shake or the like caused by the operator who holds the camera apparatus, bending occurs in the support arm 7 in response to the vibration of the chassis 2.

In accordance with the amount of the bending occurred in the support arm 7, the resistance value of the vibration detecting element 8 changes, and the change in the resistance value is output to a control unit (not illustrated) in the form of an electrical signal. In response to the electrical signal output by the vibration detecting element 8 to be input in the control unit, the amount of electric power applied to the coil 6 is controlled.

Thereby, the coil 6 vibrates in directions offsetting the vibration of the chassis 2, which is to be transmitted to the camera module 10, for example, the support member. Accordingly, the vibration of the chassis 2 is prevented from being transmitted to the camera module 10.

For example, the actuator 3 can perform control to reduce the electrical signal output by the vibration detecting element 3, in response to the vibration of the support arm 7 caused by the vibration of the chassis 2. Therefore, even if the chassis 2 vibrates due to the hand shake or the like caused by the operator who holds the camera apparatus, the actuator 3 prevents the camera module 10, which is the support member, from vibrating.

In an anti-vibration device 15 according to a second embodiment, as illustrated in FIG. 4, the actuators 3 are fixed to two positions on the chassis 2 facing each other along the X-axis directions of the camera module 10, which is the support member, and to one position on the chassis 2 along the Y-axis directions of the camera module 10. The chassis 2 is installed in a case 16a of an electronic device 16, such as a mobile phone.

According to the thus configured second embodiment, the freedom degree of positioning of the actuators 3 is increased, and designing becomes easier.

In the second embodiment, as illustrated in FIG. 4, the chassis 2 having the respective actuators 3 attached thereto is installed in the case 16a of the electronic device 16, such as the mobile phone. Alternatively, the respective actuators 3 may be directly installed in the case 16a without using the chassis 2. In this case, the chassis 2 is unnecessary, and thus the number of component parts can be reduced.

In the embodiments described above, the support member supported by the anti-vibration device 1 is the camera module 10. As well as the camera module 10, a display of a portable game machine or the like (not illustrated) may be supported by the anti-vibration device 1.

With the display thus supported by the anti-vibration device 1, even if the chassis of the portable game machine or the like vibrates when the operator operates operation buttons or the like while holding the chassis, the display does not vibrate. Therefore, a portable game machine with high visibility can be provided.

The frame 4 of the actuator 3 described above is surrounded on all four sides by the side plates and has openings at the front side and the back side in the drawings. Alternatively, the entirety of the outer circumference of the frame 4 may be enclosed by side plates such that the magnet 5 and the coil 6 provided in the frame 4 are sealed. With this configuration, penetration of dust into the frame 4 can be suppressed.

The vibration detecting element 8 described above is the resistor. Alternatively, the vibration detecting element 8 may be an acceleration sensor capable of detecting the acceleration of the vibration of the support arm 7.

The coil 6 described above has the upper end surface 6a and the lower end surface 6b, which are both supported by the resilient members 9. Alternatively, the resilient member 9 may support at least the lower end surface 6b.

The resilient member 9 described above is formed into the V-shape. Alternatively, the resilient member 9 may be formed into a plate shape.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. An anti-vibration device comprising:
a support member supported by a chassis; and
actuators fixed to the chassis and supporting the support member such that the support member can be driven to vibrate,
wherein each of the actuators supports one end portion of a cantilever support arm, and the support member is suspended and supported by the other end portion of the support arm, and
wherein the support arm is provided with a vibration detecting element which can detect vibration of the support arm which vibrates in conjunction with vibration of the chassis, and which can output a predetermined electrical signal upon detection of the vibration of the support arm.

2. The anti-vibration device according to claim 1,
wherein the actuator reduces the electrical signal output by the vibration detecting element, in response to the vibration of the support arm caused by the vibration of the chassis.

3. The anti-vibration device according to claim 2,
wherein the actuator is provided with a magnet, and a coil facing the magnet and cantilever-supporting the one end portion of the support arm, and
wherein the vibration detecting element outputs the electrical signal in response to the vibration of the chassis, and a control unit detects the electrical signal and applies predetermined electric power to the coil in response to the electrical signal to cause the coil to vibrate in directions offsetting the vibration of the chassis.

4. The anti-vibration device according to claim 3,
wherein the actuator includes a frame that has a hollow interior and is formed with mutually countervailing back and front yokes each formed of a magnetic material,
wherein the magnet is fixed to the inner surface of the back yoke of the frame, and the coil is provided to face the magnet with a gap of a predetermined side interposed between the coil and the magnet, and
wherein at least a lower end surface of the coil is supported by a resilient member attached to a lower side plate of the frame such that the coil can vibrate in directions parallel to the magnet.

5. The anti-vibration device according to claim 2,
wherein the support member includes one side surface and the other side surface, which face each other,
wherein the actuators are fixed at least to one position on the chassis that faces the one side surface and to at least two positions on the chassis that face the other side surface, and
wherein the vibration of the chassis in X-axis directions and Y-axis directions can be detected by the vibration detecting element provided to each of the actuators.

6. The anti-vibration device according to claim 3,
wherein the resilient member is formed by a blade spring, at least one end portion is fixed to the lower side plate of the frame, and the other end portion is attached to the lower end surface of the coil.

7. The anti-vibration device according to claim 2,
wherein the support arm is formed into a plate shape having resiliency, and at least one surface of the plate shape is provided with the vibration detecting element.

8. The anti-vibration device according to claim 7,
wherein the vibration detecting element is formed by a resistor formed at least on the one surface of the support arm, and
wherein, when the coil vibrates and bending occurs in the support arm, a resistance value of the resistor changes in response to the bending of the support arm, and the electrical signal is output.

9. The anti-vibration device according to claim 8,
wherein a film of the resistor is formed by printing.

10. The anti-vibration device according to claim 8,
wherein the resistor is carbon ink.

11. The anti-vibration device according to claim 7,
wherein the support member includes support portions that can be supported by the other end portion of the corresponding support arm,
wherein each of the support portions is formed with spherical surface portions or circular arc portions that face each other across a gap of a size equal to or larger than the thickness size of the corresponding plate-shaped support arm, and
wherein the support member is supported by the support arm, with the other end portion of the support arm nipped between the mutually facing spherical surface portions or circular arc portions.

12. A camera apparatus comprising:
a camera module including an optical device and an image pickup device;
a chassis that supports the camera module; and
actuators fixed to the chassis and supporting the camera module such that the camera module can be driven to vibrate,
wherein each of the actuators includes a support arm having one end portion that is cantilever-supported, and the other end portion that suspends the camera module,
wherein the support arm is provided with a vibration detecting element that detects vibration of the support arm occurring in response to vibration of the chassis, and
wherein the actuator can reduce an electrical signal output by the vibration detecting element, in response to the vibration of the support arm, and the vibration of the chassis can be prevented from being transmitted to the camera module through the control of the actuator.

13. The camera apparatus according to claim 11,
wherein the camera module and the actuators are built in a case of an electronic device, and the actuators are directly fixed to the case.
